(19) United States
(12) Patent Application Publication
(10) Pub. No.: US 2018/0230065 A1
(43) Pub. Date: Aug. 16, 2018

(54) A PROCESS OF PRODUCTION OF POTASSIUM AMMONIUM SULFATE COMPOUND FERTILIZER IN COST-EFFECTIVE MANNER DIRECTLY FROM CONCENTRATED SEA BITTERN

(71) Applicant: Council of Scientific & Industrial Research, New Delhi (IN)

(72) Inventors: Pratyush Maiti, Bhavnagar (IN); Krishna Kanta Ghara, Bhavnagar (IN); Pushpito Kumar Ghosh, Bhavnagar (IN)

(21) Appl. No.: 15/509,419

(22) PCT Filed: Oct. 16, 2015
(86) PCT No.: PCT/IN2015/050136

§ 371 Date: Mar. 7, 2017

(30) Foreign Application Priority Data
Oct. 16, 2014 (IN) 1044/DEL/2014

(51) Int. Cl. C05C 3/00; C01D 5/10

(52) U.S. Cl. CPC C05C 3/00; C01D 5/10

(57) ABSTRACT

The present invention provides process for production of potassium ammonium sulfate compound fertilizer through the reaction of Epsom salt, obtained in course of chilling of concentrated sea bittern (32-33° Be), with potassium bitartrate, precipitated from such bittern, and ammonium hydroxide. While process integration was achieved through utilisation of Epsom salt; partial desulphatation of bittern, through crystallization of Epsom salt, resulted in about 17% improvement in K⁺ precipitation efficiency.

The following specification particularly describes the invention and the manner in which it is to be performed.

### FIELD OF THE INVENTION

The present invention relates to a process for production of multi-nutrient chloride free potassic fertilizers (viz., potassium ammonium sulphate, mono potassium phosphate etc.) from sea bittern through formation and utilisation of potassium bitartrate intermediate. Particularly, the present invention derives beneficial synergies and advantages of integrated approach of the process.

### BACKGROUND AND PRIOR ART OF THE INVENTION

Multi-nutrient potassic fertilizers are widely regarded as superior fertilizers vis-à-vis muriate of potash (MOP, potassium chloride). Numerous methods have been reported for production of multi-nutrient K-fertilizers from sea bittern.

Reference may be made to U.S. Pat. No. 7,041,268, May 9, 2006 by Ghosh P. K. et al. which teaches about an integrated process for the recovery of sulphate of potash (SOP) from sulphate rich bittern. However, this process depends on evaporation of intermediate streams for production of potassium chloride, required in the process. This creates additional demand for large amount of land area apart from need effective integration of plant & field operations.

Reference may be made to the article “Multinutrient phosphate-based fertilizers from seawater bitterns” by Fernández Lozano J. A. et al., INCI v.27 n.9 Caracas set. 2002, (http://www.scielo.org.ve/scielo.php?pid=S0378-18442002000900009&script=sci_arttext), which teaches about a process for the recovery of potassium from bittern as Mg—K—PO4 fertiliser. However, Mg—K—PO4 fertiliser, having relatively low solubility, may not be able to meet peak nutrient requirement of crops.

Reference may be made to international patent application no. PCT/IB2013/000582 dated 2 Apr. 2013 by Maiti P. et al. which teaches about a method for selectively precipitating potassium from aqueous solution, e.g., schoenite end liquor, using tartaric acid as precipitant. In this process, magnesium hydroxide is consumed in the decomposition reaction of precipitated potassium bitartrate. Although integration with magnesium hydroxide production has been envisaged in the proposed scheme, this imposes an unwarranted prerequisite on standalone potash manufacturing units. Additionally, while using bittern as K-bearing feedstock, this process suffers from low potash recovery, ca. 60%.

Thus a need was felt to devise a process for production of multi-nutrient potassic fertiliser by selectively precipitating potassium from bittern as potassium bitartrate in high yield and converting the same to desired mixed/compound fertiliser, with thrust on simple process integration and utilisation of cheap raw materials.

### OBJECTS OF THE INVENTION

The main object of the invention is to provide an integrated process for production of potassium ammonium sulfate compound fertilizer through the reaction of Epsom salt, obtained in course of chilling of concentrated sea bittern (ca. 33° Be), with potassium bitartrate, precipitated from such bittern, and ammonium hydroxide.

Another object of the invention is to recover potassium from sea bittern in high yield.

Another object of the invention is to minimize residual tartaric acid content in K-depleted bittern to facilitate effluent discharge.

Another object of the invention is to effect easy recycling of tartaric acid by converting calcium tartrate to water soluble tartrate solution.

Another object of the invention is to produce various other multi-nutrient potash fertilizers viz., mono potassium phosphate etc. by use of appropriate reagent.

### BRIEF DESCRIPTION OF THE DRAWING

FIG. 1 represents process scheme for production of potassium ammonium sulfate from concentrated sea bittern.

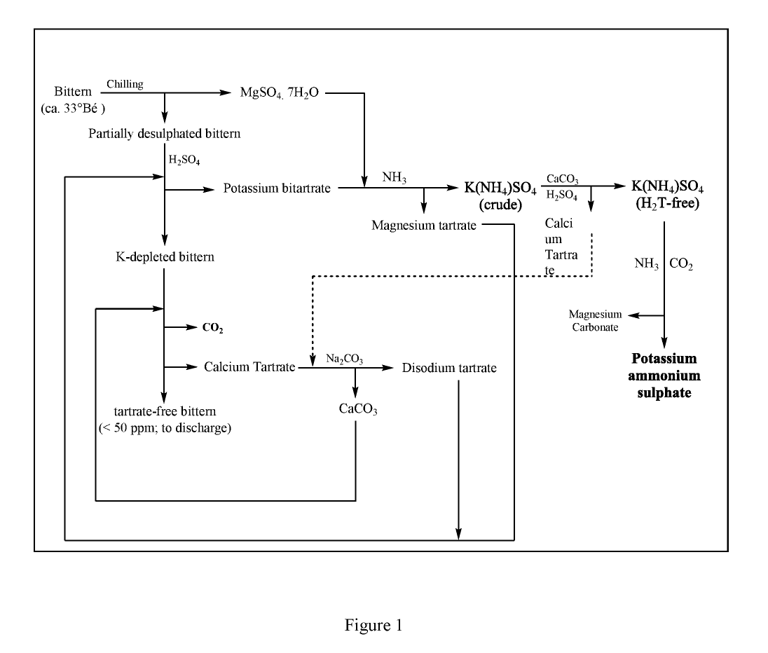

### SUMMARY OF THE INVENTION

1. Accordingly, present invention provides
2. An integrated process for production of potassium ammonium sulphate compound fertilizer, by recovering potassium from sea bittern, through the reaction of Epsom salt, obtained in course of chilling of concentrated sea bittern (32-33° Be), with potassium bitartrate, precipitated from such bittern, and ammonium hydroxide and the said process comprising the steps of:
   i. concentrating sea bittern to 32 to 33° Be;
   ii. adding 5 to 10% water into the concentrated sea bittern followed by chilling at a temperature range of 0° C.-7° C. for recovery of Epsom salt and partially desulphated bittern;
   iii. reacting the partially de-sulphated bittern with magnesium tartrate and sulphuric acid to obtain potassium bitartrate and K-depleted bittern;
   iv. reacting potassium bi-tartrate with Epsom salt as obtained in step (ii) and ammonia solution to produce K(NH₄)SO₄ solution and to precipitate magnesium tartrate;
   v. treating the K(NH₄)SO₄ solution obtained in step (iv) with calcium carbonate or calcium oxide and sulphuric acid, to obtain solid calcium tartrate and K(NH₄)SO₄ solution;
   vi. treating the K(NH₄)SO₄ solution obtained in step (v) with ammonia and carbon dioxide, to precipitate residual Mg²⁺ as magnesium carbonate and generate nearly pure K(NH₄)SO₄ solution;
   vii. mixing the K-depleted bittern obtained in step (iii) with water/seawater and reacting the dilute bittern with calcium carbonate or calcium oxide and sulphuric acid to precipitate out residual tartaric acid in the form of insoluble calcium tartrate;
   viii. reacting calcium tartrate, obtained in steps (v) and (vii), with sodium carbonate to produce solution of disodium tartrate along with precipitation of calcium carbonate;
   ix. adding the magnesium tartrate, obtained in step (iv) and disodium tartrate, obtained in step (viii) into a fresh lot of partially de-sulphated bittern along with sulphuric acid to once again precipitate out potassium bi-tartrate;
   x. using the calcium carbonate, obtained in step (viii), in steps (v) and (vii);
   xi. evaporating the K(NH₄)SO₄ solution obtained in step (vi) to produce solid potassium ammonium sulphate compound fertilizer.

In an embodiment of the present invention, partial desulphatation of bittern, by way of crystallisation of Epsom salt, resulted in higher (>17%) potassium bitartrate yield.

In another embodiment of the present invention, dilution of K-depleted bittern, with water/sea water, resulted in steep reduction of residual tartaric acid in effluent (<50 ppm).

In another embodiment of the present invention, part of the tartaric acid was recycled as disodium tartrate, prepared from insoluble calcium tartrate.

### DETAIL DESCRIPTION OF THE INVENTION

The present invention provides a simplified integrated process for production of potassium ammonium sulphate through selective potassium recovery from sea bittern and the said process comprises following major steps:
(i) concentrating sea bittern to ca. 33° Be, through solar evaporation;
(ii) chilling the concentrated sea bittern for recovery of Epsom salt;
(iii) reacting the partially de-sulphated bittern with magnesium tartrate and sulphuric acid to effect precipitation of potassium bitartrate;
(iv) reacting potassium bi-tartrate with Epsom salt and ammonia solution to produce K(NH₄)SO₄ solution and to precipitate magnesium tartrate;
(v) treating the K(NH₄)SO₄ solution obtained in step (iv) with calcium carbonate/calcium oxide and sulphuric acid, to precipitate residual tartrate as calcium tartrate;
(vi) treating the K(NH₄)SO₄ solution obtained in step (v) with ammonia and carbon dioxide, to precipitate residual Mg²⁺ as magnesium carbonate;
(vii) mixing the K-depleted bittern obtained in step (iii) with water/seawater and reacting the dilute bittern with calcium carbonate/calcium oxide and sulphuric acid to precipitate out residual tartaric acid in the form of insoluble calcium tartrate;
(viii) reacting calcium tartrate, obtained in steps (v) and (vii), with sodium carbonate to produce solution of disodium tartrate along with precipitation of calcium carbonate;
(ix) adding the magnesium tartrate, obtained in step (iv) and disodium tartrate, obtained in step (viii) into a fresh lot of partially de-sulphated bittern along with sulphuric acid to once again precipitate out potassium bi-tartrate;
(x) using the calcium carbonate, obtained in step (viii), in steps (v) and (vii);
(xi) evaporating the K(NH₄)SO₄ solution obtained in step (vi) to produce solid potassium ammonium sulphate.

The present invention provides a simplified integrated process for production of potassium ammonium sulphate through selective potassium recovery from sea bittern, such process comprising (i) concentrating sea bittern to 32-33° Be (nominal K concentration: 1.8-2.4% w/v), preferably through solar evaporation; (ii) adding 5-10% water into the concentrated sea bittern and chilling the resultant solution, preferably to 0±7° C.; (iii) separating out and washing the precipitated Epsom salt with water; (iv) recycling the wash liquor of step (iii) in subsequent lot of concentrated sea bittern in step (ii), partially replacing water; (v) reacting the partially de-sulphated bittern obtained from step (iii) with tartaric acid, half-neutralized with magnesium hydroxide to effect precipitation of potassium bitartrate; (vi) separating out and washing the precipitated potassium bitartrate with water; (vii) adding the wash liquor in K-depleted bittern obtained from step (vi); (viii) reacting the potassium bitartrate obtained from step (vi) with the Epsom salt obtained from step (iii) and liquor ammonia, in aqueous media; (ix) separating out and washing the precipitated magnesium tartrate with water; (x) recycling the wash liquor of step (ix) in step (viii); (xi) reacting the K(NH₄)SO₄ solution obtained from step (ix) with calcium carbonate/calcium oxide and sulphuric acid; (xii) separating out and washing the precipitated calcium tartrate with water; (xiii) recycling the wash liquor of step (xii) in step (viii); (xiv) reacting the tartrate-free K(NH₄)SO₄ solution obtained from step (xii) with ammonia and carbon dioxide; (xv) separating out and washing the precipitated magnesium carbonate with water; (xvi) recycling the wash liquor of step (xv) in step (viii); (xvii) evaporating the K(NH₄)SO₄ solution obtained from step (xv) to produce solid potassium ammonium sulphate; (xviii) adding water/seawater (50-100%) into the K-depleted bittern of step (vi) and reacting the solution with calcium carbonate/calcium oxide and sulphuric acid; (xix) separating out and washing the precipitated calcium tartrate with water; (xx) recycling the wash liquor of step (xix) in step (xviii); (xxi) discarding the spent bittern of step (xix) as process discharge; (xxii) reacting the calcium tartrate from steps (xii) and (xix) with slight excess (0-10%) of sodium carbonate in aqueous media; (xxiii) separating out and washing the precipitated calcium carbonate with water; (xxiv) recycling the wash liquor of step (xxiii) in step (xxii); (xxv) recycling the calcium carbonate of step (xxiii) in steps (xi) and (xviii); (xxvi) adding magnesium tartrate, obtained from step (ix), and disodium tartrate solution, obtained from step (xxiii), and sulphuric acid into a fresh lot of partially de-sulphated bittern in step (v), to effect potassium bitartrate precipitation.

In one embodiment, potassium bitartrate yield was >75%, with respect to K⁺ content of sea bittern.

In another embodiment, partial desulphatation of bittern resulted in higher potassium bitartrate yield.

In another embodiment, residual Mg²⁺ and tartrate content in treated K(NH₄)SO₄ solution were reduced to 200 ppm and 320 ppm respectively.

In another embodiment, residual tartrate content of K⁺-depleted bittern, diluted with water in 1:1 ratio (v/v), was reduced to 48 ppm.

In another embodiment, disodium tartrate yield was >94% with respect to tartrate content of calcium tartrate.

In another embodiment, potassium bitartrate was used for preparation of mono potassium phosphate.

The main inventive step is the process integration and simplification achieved by reacting Epsom salt, recovered upon chilling of concentrated bittern, with potassium bitartrate and ammonium hydroxide to produce K(NH₄)SO₄.

Another inventive step is to carry out potassium bitartrate precipitation from partially desulphated bittern, leading to significantly higher potassium recovery.

Another inventive step is to dilute the K-depleted bittern with water/seawater, resulting in manifold gain with respect to recovery of residual tartrate.

Another inventive step is to convert calcium tartrate to water soluble disodium tartrate, thereby allowing easier recycling of residual tartrates.

Another inventive step is to purify the K(NH₄)SO₄ solution, obtained upon decomposition of potassium bitartrate, by (a) removal of residual tartrate as calcium tartrate and (b) removal of residual Mg²⁺ as magnesium carbonate.

### EXAMPLES

The following examples are given by way of illustration and therefore should not be construed to limit the scope of the present invention.

### Example 1

144.1 gm Epsom salt [Mg²⁺: 10.52%, Na⁺: 0.101% (w/w)], obtained upon chilling of sea bittern [specific gravity: 1.288, K⁺: 2.47%, Na⁺: 2.60%, Mg²⁺: 7.50%, SO₄²⁻: 9.00%, Cl⁻: 20.38% (w/v)] at 5±1° C., was dissolved in 600 mL water under stirring. 100 gm potassium bitartrate [K⁺: 22.00%, H₂T: 75.01% (w/w)] and 37 mL liquor ammonia (23% w/v) were added into the solution sequentially. Stirring was continued for 12 hrs, maintaining the temperature at 28±3° C. Final pH of the reaction mixture was 7.2. Upon filtration of the resultant slurry, 600 mL filtrate [K⁺: 3.01%, NH₄⁺: 1.03%, SO₄²⁻: 10.56%, Mg²⁺: 0.61%, H₂T: 1.66% (w/v)] was obtained. The wet crystalline residue was subsequently washed with 150 mL water and air-dried to obtain 107 gm magnesium tartrate [Mg²⁺: 10.9%, K⁺: 0.1%, H₂T: 54.67% (w/w)].

Example 1 teaches us the method for production of K(NH4)SO4 solution by reacting Epsom salt with potassium bitartrate and ammonium hydroxide.

### Example 2

300 mL concentrated sea bittern [specific gravity: 1.287, K⁺: 2.22%, Na⁺: 2.58%, Mg²⁺: 7.94%, SO₄²⁻: 8.31%, Cl⁻: 21.21% (w/v)] was mixed 60 mL water, 3.45 gm magnesium oxide and 25.67 gm DL-tartaric acid (H₂T) under stirring. Stirring was continued for 24 hrs, maintaining the temperature at 22±3° C. Final pH of the reaction mixture was 0.98. Upon filtration of the resultant slurry, 342 mL filtrate [K⁺: 0.58%, H₂T: 2.05% (w/v)] was obtained. The wet crystalline residue was subsequently washed with small aliquot of water and air-dried to obtain 22.33 gm potassium bitartrate [K: 19.04%, H₂T: 76.05% (w/w)]. Potassium bitartrate yield was 63.71% with respect to K⁺ content in the concentrated sea bittern.

### Example 3

300 mL partially desulphated bittern, obtained after recovery of Epsom salt, [specific gravity: 1.26, K⁺: 2.16%, Na⁺: 2.36%, Mg²⁺: 6.58%, SO₄²⁻: 5.30%, Cl⁻: 20.28% (w/v)] was mixed 30 mL water, 3.35 gm magnesium oxide and 24.91 gm H₂T under stirring. Stirring was continued for 24 hrs, maintaining the temperature at 22±3° C. Final pH of the reaction mixture was 0.99. Upon filtration of the resultant slurry, 310 mL filtrate [K⁺: 0.43%, H₂T: 1.76% (w/v)] was obtained. The wet crystalline residue was subsequently washed with small aliquot of water and air-dried to obtain 27.33 gm potassium bitartrate [K: 17.91%, H₂T: 66.98% (w/w)]. Potassium bitartrate yield was 75.57% with respect to K⁺ content in the partially desulphated sea bittern.

Examples 2 and 3 teach us that partial desulphatation of concentrated sea bittern improves potassium bitartrate yield.

### Example 4

20 gm gypsum was added into 500 mL filtrate, obtained in example 1, under stirring. Stirring was continued for 12 hrs, maintaining the temperature at 28±3° C. Final pH of the reaction mixture was 6.5. Upon filtration of the resultant slurry, 420 mL filtrate [K⁺: 3.53%, NH₄⁺: 1.21%, SO₄²⁻: 12.39%, Mg²⁺: 0.78%, Ca²⁺: 0.04%, H₂T: 0.032% (w/v)] was obtained. The wet crystalline residue was subsequently washed with 100 mL water and air-dried to obtain 32 gm solid [K⁺: 1.87%, H₂T: 45.00% (w/w)].

### Example 5

300 mL filtrate, obtained in example 4, was reacted with 15 mL liquor ammonia (23% w/v) and Carbon dioxide gas was purged into the reaction mixture under stirring. The reaction was continued for 4 hrs, maintaining the temperature at 28±3° C. Final pH of the reaction mixture was 7.5. Upon filtration of the resultant slurry, 280 mL filtrate, [Mg²⁺: 0.102% (w/v)] was obtained which on partial evaporation yielded solid potassium ammonium sulphate [K⁺: 25.02%, NH₄⁺: 12.79%, SO₄²⁻: 63.10%, Mg²⁺: 0.02%, Na⁺: 0.03%, Cl⁻: 0.01% (w/w)]. Examples 4 and 5 teach us methods for purification of K(NH₄)SO₄ solution.

### Example 6

150 mL K-depleted bittern [H₂T: 1.08% (w/v)], obtained after precipitation of potassium bitartrate, was reacted with 1.08 gm CaCO3 and 3.72 gm gypsum under stirring. Stirring was continued for 12 hrs maintaining the temperature at 25±1° C. Final pH of reaction mixture was 6.8. Upon filtration of resultant slurry, 125 mL filtrate [H₂T: 0.82% (w/v)] was obtained.

### Example 7

150 mL K-depleted bittern of example 6 was mixed with 150 mL water and reacted with 1.08 gm CaCO3 and 3.72 gm gypsum under stirring. Stirring was continued for 3 hrs maintaining the temperature at 25±1° C. Final pH of reaction mixture was 6.78. Upon filtration of resultant slurry, 270 mL filtrate [H₂T: 141 ppm] was obtained. When the same reaction was carried out at 5±1° C. for 12 hrs, residual tartrate content in filtrate became 48 ppm.

### Example 8

150 mL K-depleted bittern [H₂T: 1.41% (w/v)], obtained after precipitation of potassium bitartrate, was mixed with 150 mL sea water and reacted with 1.41 gm CaCO3 and 4.85 gm gypsum under stirring. Stirring was continued for 12 hrs maintaining the temperature at 5±1° C. Final pH of reaction mixture was 6.85. Upon filtration of resultant slurry, 268 mL filtrate [H₂T: 56 ppm] was obtained.

Examples 6, 7 and 8 teach us that dilution of K-depleted bittern with water/sea water enhances residual tartaric recovery.

### Example 9

3.11 gm sodium carbonate was dissolved in 80 mL water under stirring. The solution was heated to maintain the temperature at 60±1° C. 6.9 gm calcium tartrate [Ca²⁺: 15.32%, H₂T: 57.45% (w/w)] was slowly added into the solution. Stirring was continued for 4 hrs maintaining the temperature. Upon filtration of resultant slurry, 74 mL filtrate [Na^{t}: 1.67%, H₂T: 5.06% (w/v)] and 3.6 gm solid [H₂T: 6.0% (w/w)] was obtained. Conversion of calcium tartrate into water soluble disodium tartrate was ca. 94%.

Examples 9 teaches us method of conversion of calcium tartrate to disodium tartrate.

### Example 10

100 gm potassium bitartrate [K⁺: 16.24%, H₂T: 65.87% (w/w)] was dispersed in 500 mL water under stirring. 23.3 mL phosphoric acid (88% w/v) and 41.64 gm calcium carbonate were added into the slurry sequentially. Stirring was continued for 12 hrs, maintaining the temperature at 28±3° C. Final pH of the reaction mixture was 5.2. Upon filtration of the resultant slurry, 375 mL filtrate [K⁺: 2.91%, Ca²⁺: 0.02%, H₂T: 0.38% (w/v)] was obtained. The wet residue was washed with 80 mL water and air-dried to obtain 123 gm solid [Ca²⁺: 17.97%, K⁺: 1.86%, H₂T: 51.00% (w/w)]. The filtrate was subsequently evaporated to obtain crystalline mono potassium phosphate.

Example 10 teaches us the method for production of mono potassium phosphate using potassium bitartrate.

### ADVANTAGES OF THE PRESENT INVENTION

The present invention provides a simplified integrated process for production of potassium ammonium sulphate through selective potassium recovery from sea bittern in reasonably high yield, thereby eliminating the need for evaporation of bittern to generate potash bearing evaporite—feed stock for conventional sea bittern based potash fertiliser production processes.

Main advantages of the present invention may be stated as follows:
i) Simple process integration in utilising Epsom salt, obtained in course of partial desulphatation of concentrated sea bittern, and ammonia in decomposition of potassium bitartrate results in production of multi-nutrient (N/K/S) fertiliser.
ii) Higher potash recovery efficiency, through partial desulphatation of concentrated sea bittern.
iii) Relatively low tartaric acid content (<50 ppm) in spent bittern facilitates effluent discharge with reduced intervention.

We claim:

1. An integrated process for production of potassium ammonium sulphate compound fertilizer, by recovering potassium from sea bittern, through the reaction of Epsom salt, obtained in course of chilling of concentrated sea bittern (32-33° Be), with potassium bitartrate, precipitated from such bittern, and ammonium hydroxide and the said process comprising the steps of:
i. concentrating sea bittern to 32 to 33° Be;
ii. adding 5 to 10% water into the concentrated sea bittern followed by chilling at a temperature range of 0° C.-7° C. for recovery of Epsom salt and partially desulphated bittern;
iii. reacting the partially de-sulphated bittern with magnesium tartrate and sulphuric acid to obtain potassium bitartrate and K-depleted bittern;
iv. reacting potassium bi-tartrate with Epsom salt as obtained in step (ii) and ammonia solution to produce K(NH₄)SO₄ solution and to precipitate magnesium tartrate;
v. treating the K(NH₄)SO₄ solution obtained in step (iv) with calcium carbonate or calcium oxide and sulphuric acid, to obtain solid calcium tartrate and K(NH₄)SO₄ solution;
vi. treating the K(NH₄)SO₄ solution obtained in step (v) with ammonia and carbon dioxide, to precipitate residual Mg²⁺ as magnesium carbonate and generate nearly pure K(NH₄)SO₄ solution;
vii. mixing the K-depleted bittern obtained in step (iii) with water/seawater and reacting the dilute bittern with calcium carbonate or calcium oxide and sulphuric acid to precipitate out residual tartaric acid in the form of insoluble calcium tartrate;
viii. reacting calcium tartrate, obtained in steps (v) and (vii), with sodium carbonate to produce solution of disodium tartrate along with precipitation of calcium carbonate;
ix. adding the magnesium tartrate, obtained in step (iv) and disodium tartrate, obtained in step (viii) into a fresh lot of partially de-sulphated bittern along with sulphuric acid to once again precipitate out potassium bi-tartrate;
x. using the calcium carbonate, obtained in step (viii), in steps (v) and (vii);
xi. evaporating the K(NH₄)SO₄ solution obtained in step (vi) to produce solid potassium ammonium sulphate compound fertilizer.

2. The process as claimed in claim 1, wherein partial desulphatation of bittern, by way of crystallisation of Epsom salt, resulted in higher (>17%) potassium bitartrate yield.

3. The process as claimed in claim 1, wherein dilution of K-depleted bittern, with water/sea water, resulted in steep reduction of residual tartaric acid in effluent (<50 ppm).

4. The process as claimed in claim 1, wherein part of the tartaric acid was recycled as disodium tartrate, prepared from insoluble calcium tartrate.
